(19) United States
(12) Patent Application Publication
(10) Pub. No.: US 2010/0053265 A1
(43) Pub. Date: Mar. 4, 2010

(54) ARRAY TYPE INKJET PRINT HEAD AND IMAGE FORMING APPARATUS HAVING THE SAME

(75) Inventors: Jung-wook KIM, Yougin-si (KR); Young-su Lee, Suwon-si (KR); In-su Lee, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/485,346

(22) Filed: Jun. 16, 2009

(30) Foreign Application Priority Data
Sep. 3, 2008 (KR) 2008-86874

(51) Int. Cl. B41J 2/145

(52) U.S. Cl. 347/40

(57) ABSTRACT

An array type inkjet print head includes an ink cartridge to store ink, at least one print head chip disposed on a base of the ink cartridge to project from the base, the at least one print head chip to fire the ink, a flat plate cover disposed on the base of the ink cartridge and to have at least one opening corresponding to the at least one print head chip, and an adhesive member disposed between the base of the ink cartridge and the flat plate cover to fix the flat plate cover to the base of the ink cartridge. The flat plate cover is formed of either a metal material or a ceramic material.

### CROSS-REFERENCE TO RELATED APPLICATIONS

This application claims priority under 35 U.S.C. §119(a) from Korean Patent Application No. 2008-86874 filed Sep. 3, 2008 in the Korean Intellectual Property Office, the disclosure of which is incorporated herein by reference in its entirety.

### BACKGROUND

1. Field of the Invention

The present general inventive concept relates to an image forming apparatus to print using an inkjet print head. More particularly, the present general inventive concept relates to an array type inkjet print head capable of printing at a high speed, and an image forming apparatus having the same.

2. Description of the Related Art

Generally, an inkjet print head has at least one print head chip to include a plurality of nozzles to eject ink. A heater to heat ink is disposed below each nozzle of the print head chip. Therefore, the heater heats ink so a predetermined amount of ink is ejected through the nozzle.

As technologies have advanced, the number of nozzles per unit area of the print head chip, that is, nozzle density of the print head chip, has increased. If the print head chip has a high nozzle density, the number of nozzles per unit area can be increased such that a phenomenon in which a printing operation is not performed due to overheating tends to occur. In addition, because an array type inkjet print head having an arranged plurality of print head chips has more heaters than an inkjet print head having only one print head chip, the phenomenon of a printing operation not being performed due to overheating can occur more frequently.

Therefore, the development of an inkjet print head that can decrease the phenomena of a printing operation not being performed due to overheating is required.

### SUMMARY

The present general inventive concept has been developed in order to overcome the above drawbacks and other problems associated with the conventional arrangement. The present general inventive concept provides an array type inkjet print head having good heat radiation performance, and an image forming apparatus having the same.

Additional features and utilities of the present general inventive concept will be set forth in part in the description which follows and, in part, will be obvious from the description, or may be learned by practice of the general inventive concept.

Exemplary embodiments of the present general inventive concept may be achieved by providing an array type inkjet print head, including an ink cartridge to store ink, at least one print head chip disposed on a base of the ink cartridge to eject the ink, a flat plate cover disposed on the base of the ink cartridge and having at least one opening corresponding to the at least one print head chip, and an adhesive member disposed between the base of the ink cartridge and the flat plate cover to fix the flat plate cover to the base of the ink cartridge, wherein the flat plate cover is formed of either a metal material or a ceramic material.

The adhesive member may be formed of a heat conductive material.

The adhesive member may be formed to have a thickness of approximately 50 μm to approximately 300 μm.

The adhesive member may have heat conductivity of 0.3 W/mK or more.

The adhesive member may include at least one of a liquid adhesive and a solid adhesive having at least one hole corresponding to the at least one print head chip.

The adhesive member may include an epoxy resin or a denatured epoxy resin of at least 1 weight percent.

The metal material may include stainless steel, copper, aluminum, and an alloy including at least one of stainless steel, copper, and aluminum.

The ceramic material may include at least one of alumina, zirconia, and a compound including at least one of alumina and zirconia.

The flat plate cover may have a thickness of approximately 0.1 mm to approximately 1.0 mm.

Exemplary embodiments of the present general inventive concept may also be achieved by providing an image forming apparatus including a feeding unit to feed a printing medium, an array type inkjet print head to form images on the printing medium fed by the feeding unit, the array type inkjet print head comprising: an ink cartridge to store ink, at least one print head chip disposed on a base of the ink cartridge to eject the ink, a flat plate cover disposed on the base of the ink cartridge and to have at least one opening corresponding to the at least one print head chip, the flat plate cover formed of either a metal material or a ceramic material, and an adhesive member disposed between the base of the ink cartridge and the flat plate cover to fix the flat plate cover to the base of the ink cartridge, and a discharging unit to discharge the printing medium printed by the array type inkjet print head.

Exemplary embodiments of the present general inventive concept may also be achieved by providing an array type inkjet print head, including an ink cartridge to store ink; a print head chip disposed on the ink cartridge, and a cover having a first portion to cover an area of the ink cartridge where the print head chip is not disposed and a second portion extended from the first portion to cover a side of the ink cartridge, and an adhesive member disposed between the first portion of the cover and the ink cartridge.

The ink cartridge may include an ink storage and a base to connect the ink storage to the print head chip, and the adhesive member may be disposed between the first portion of the cover and the base.

The inkjet print head may further include an electrical connecting member disposed between the second portion of the cover and the side of the ink cartridge to provide electrical signals to the print head chip.

The second portion may cover at least a portion of the electrical connecting member.

The cover may have a third portion extended from the first portion to cover a different side of the ink cartridge.

The adhesive member may be thermally conductive, may have a thermal conductivity of at least 0.3 W/mK, and also may have a thickness of approximately 50 μm to approximately 300 μm. The adhesive member may include one of a liquid adhesive and a solid adhesive.

Exemplary embodiments of the present general inventive concept may also be achieved by providing an array type ink jet print head, including an ink cartridge having a print head chip disposed on a surface thereof, a cover disposed on the surface of the ink cartridge formed to substantially enclose sides of the print head chip, and an adhesive member disposed between the surface of the ink cartridge and the cover.

The adhesive member may have a thermal conductivity of at least 0.3 W/mK, may have a thickness of approximately 50 μm to approximately 300 μm, and may include one of a liquid adhesive and a solid adhesive.

The cover may be thermally conductive, and may include at least one of a metal material and a ceramic material.

The metal material may include stainless steel, copper, aluminum, and an alloy including at least one of stainless steel, copper, and aluminum.

The ceramic material may include at least one of alumina, zirconia, and a compound including at least one of alumina and zirconia.

Exemplary embodiments of the present general inventive concept may also be achieved by providing an image forming apparatus, including an ink jet print head to eject ink onto a recording medium fed by a feeding unit, the print head including an ink cartridge having a print head chip disposed on a surface thereof, a cover disposed on the surface of the ink cartridge formed to substantially enclose sides of the print head chip, and an adhesive member disposed between the surface of the ink cartridge and the cover.

The adhesive member may have a thermal conductivity of at least 0.3 W/mK, may have a thickness of approximately 50 μm to approximately 300 μm, and may include one of a liquid adhesive and a solid adhesive.

The cover may be thermally conductive, and may include at least one of a metal material and a ceramic material. The metal material may include stainless steel, copper, aluminum, and an alloy including at least one of stainless steel, copper, and aluminum. The ceramic material may include at least one of alumina, zirconia, and a compound including at least one of alumina and zirconia.

Exemplary embodiments of the present general inventive concept may also be achieved by providing a method of dispersing heat in an array type inkjet print head having an ink cartridge and a print head disposed on a surface of the ink cartridge, the method including performing a print operation with the print head, conducting heat generated in the print head chip during the printing operation away from the print head chip with an adhesive member and a cover, and radiating the heat externally from the inkjet print head with the adhesive member and the cover.

### BRIEF DESCRIPTION OF THE DRAWINGS

These and/or other features and utilities of the present general inventive concept will become apparent and more readily appreciated from the following description of the exemplary embodiments, taken in conjunction with the accompanying drawings of which:

FIG. 1 is a perspective view illustrating an array type inkjet print head according to exemplary embodiments of the present general inventive concept;

FIG. 2 is an exploded perspective view illustrating the array type inkjet print head of FIG. 1;

FIG. 3 is a sectional view illustrating the array type inkjet print head of FIG. 1 taken along a line 3-3 in FIG. 1;

FIG. 4 is a partial sectional view illustrating a relationship between a surface of a flat plate cover and a surface of a print head chip of an array type inkjet print head according to exemplary embodiments of the present general inventive concept;

FIGS. 5A to 5C are process views illustrating a method to manufacture an array type inkjet print head according to exemplary embodiments of the present general inventive concept;

FIG. 6A to 6C are process views illustrating a method to manufacture an array type inkjet print head according to exemplary embodiments of the present general inventive concept; and

FIG. 7 is a sectional view schematically illustrating an image forming apparatus using an array type inkjet print head according to exemplary embodiments of the present general inventive concept.

### DETAILED DESCRIPTION OF THE EMBODIMENTS

Reference will now be made in detail to exemplary embodiments of the present general inventive concept, examples of which are illustrated in the accompanying drawings, wherein like reference numerals refer to the like elements throughout. The exemplary embodiments are described below in order to explain the present general inventive concept by referring to the figures.

The matters described herein, such as a detailed construction of the exemplary embodiments and elements thereof, are provided to assist in a comprehensive understanding of the present general inventive concept. It will be apparent that the present general inventive concept may be carried out without being limited to the specific exemplary embodiments described herein. Also, well-known functions or constructions may be omitted to provide a clear and concise description of the exemplary embodiments of the present general inventive concept.

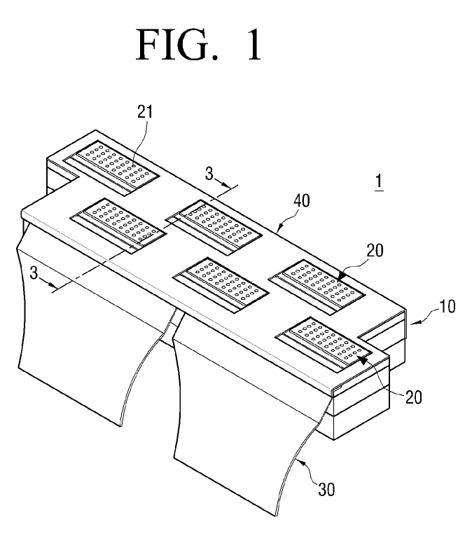

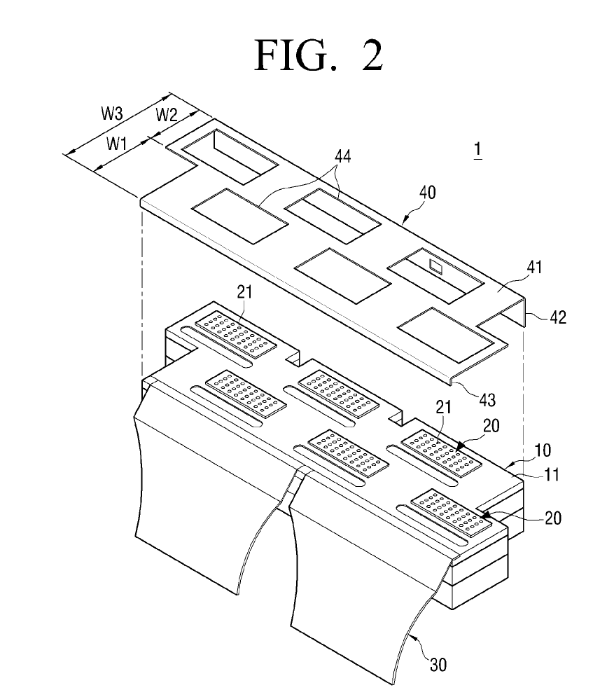

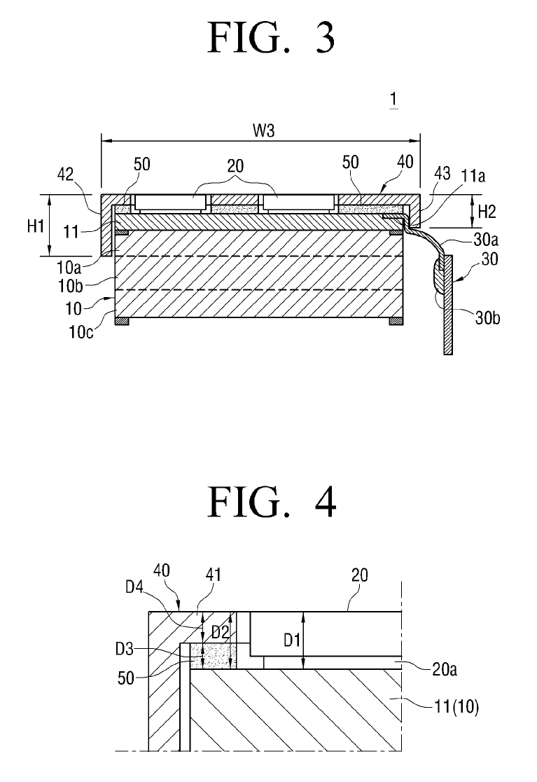

FIG. 1 is a perspective view illustrating an array type inkjet print head 1 according to exemplary embodiments of the present general inventive concept. FIG. 2 is an exploded perspective view illustrating the array type inkjet print head 1 of FIG. 1. FIG. 3 is a sectional view illustrating the array type inkjet print head 1 of FIG. 1 taken along a line 3-3 in FIG. 1. FIG. 3 illustrates a structure between a base 11 and a flat plate cover 40 of an ink cartridge 10.

Referring to FIGS. 1 to 3, the array type inkjet print head 1 according to exemplary embodiments of the present general inventive concept includes the ink cartridge 10 and the flat plate cover 40. In the description below, the array type inkjet print head 1 having a plurality of print head chips 20 is described as only an example. However, the present general inventive concept is not limited to an array type inkjet print head. In exemplary embodiments, the array type inkjet print head 1 can be an inkjet print head configured to print the entire size (that is, a printing width of the printing medium) of a printing medium in a direction transverse to a direction in which the printing medium is transferred without moving among various inkjet print heads used in image forming apparatuses that eject ink to print images.

The array type inkjet print head 1 may be formed as one print head chip having a length corresponding to the printing width of the printing medium. Alternatively, the array type inkjet print head 1 may be configured with a plurality of print head chips 20, each of which has a length shorter than the printing width of the printing medium, arrayed to correspond to the printing width of the printing medium.

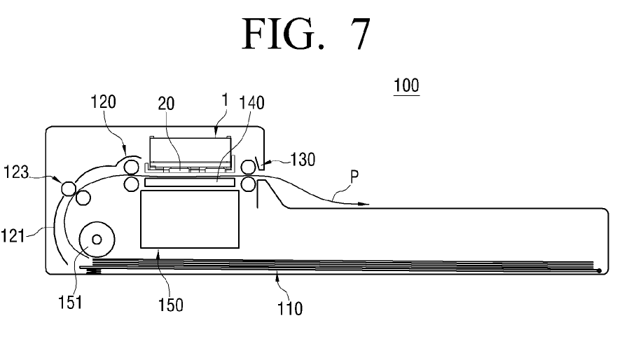

The ink cartridge 10 may store a predetermined amount of ink, and may include a base 11 and the plurality of print head chips 20 disposed on the base 11. The plurality of print head chips 20, as illustrated in FIG. 7, is disposed to face the printing medium P. Each of the plurality of print head chips 20 has a plurality of nozzles 21 to eject ink and a plurality of heaters (not illustrated) corresponding to the plurality of nozzles 21. Each of the plurality of heaters is disposed below each of the plurality of nozzles 21 inside the print head chip 20. Inside the ink cartridge 10 an ink storing portion (not illustrated) and an ink supply passage (not illustrated) can be formed to allow the ink to be supplied from the ink storing portion to the plurality of print head chips 20. For example, an ink storing portion can be formed in ink cartridge layer 10c, and an ink passage or ink passages can be formed in ink cartridge layers 10b and 10a and in the base 11 to direct ink from the ink storage portion to the print head chips 20 and the corresponding nozzles 21 to be ejected by the print head chips. The ink stored in the ink storing portion can be of any color, for example, black, cyan, yellow, or magenta ink, so that the array type inkjet print head 1 can print images in black and white and in color. In addition, the ink storage portion can also be directly connected to the print head chips 20 and/or the corresponding nozzles 21,

Furthermore, an electrical connecting member 30 to supply the plurality of print head chips 20 with electrical signals and electric power to control ink ejections may be disposed at a side of the ink cartridge 10. A flexible printed circuit board, for example, may be used as the electrical connecting member 30. As illustrated in FIG. 3, electrical connecting member 30 may have a connecting portion 30a to connect electrical connecting member 30 to the base 11 at a base groove 11a. Base 11 may have electrically conductive parts (not illustrated) to connect electrical connecting member 30 to the plurality of print head chips 20. Connecting portion 30a may have terminals to connect the electrical connecting member 30 to the electrically conductive parts in base 11. Connecting portion 30a may be flexible or rigid according to exemplary embodiments, and may connect to electrical connecting member 30 at a terminal 30b.

The base 11 is configured so that the plurality of print head chips 20 are disposed at predetermined intervals. The flat plate cover 40 is disposed on a surface of the base 11. The base 11 may be formed of a ceramic or a plastic injection material.

In exemplary embodiments, as illustrated in FIGS. 1 and 2, the array type inkjet print head 1 can have six print head chips 20, and the six print head chips 20, can be disposed in two rows on the base 11 of the ink cartridge 10. However, this does not limit the number of and/or arrangement of the print head chips 20 that the inkjet print head 1 according to exemplary embodiments of the present general inventive concept may include.

The plurality of print head chips 20, as illustrated in FIGS. 2 and 3, can be disposed to protrude from the surface of the base 11 of the ink cartridge 10. The height which the print head chips 20 to protrude from the base 11 can depend on the thickness of the print head chip 20. In exemplary embodiments, the print head chips 20 may be formed to protrude approximately 1 mm from the base 11. In addition, if the base 11 of the ink cartridge 10 is formed of either a ceramic or a plastic injection material, the surface of the base 11 may have a flatness of approximately 50 μm or more.

The flat plate cover 40 is disposed on the surface of the base 11 of the ink cartridge 10. The flat plate cover 40, as illustrated in FIGS. 2 and 3, may be formed in a substantially flattened U shape and may have a body portion 41 and two sidewalls 42 and 43. As illustrated in FIG. 2, the body portion 41 of flat plate cover 40 may have two sections each corresponding to one row of the plurality of print head chips 20. A first section may have a width W1, and a second section of may have a width W2. The width of the two sections together may form a width W3, which is the distance of the body portion 41 between the two sidewalls 42 and 43. However, this is illustrated only as an example, and exemplary embodiments of the flat plate cover 40 may be formed in any number of shapes and configurations, for example, in a substantially rectangular shape, or in any shape or configuration to accommodate a desired number and configuration of print head chips 20. The body portion 41 can be bonded to the base 11 of the ink cartridge 10 and has a plurality of openings 44 to correspond to the plurality of print head chips 20. The two sidewalls 42 and 43 can extend from opposite sides of the body portion 41 so that when the flat plate cover 40 is assembled to the ink cartridge 10, the two sidewalls 42 and 43 cover opposite side surfaces of the base 11 of the ink cartridge 10. Alternatively, although not illustrated, the flat plate cover 40 may also be formed to have no sidewall or only one sidewall 42 or 43. Sidewall 42 may have a height H1, and sidewall 43 may have a height H2. Sidewall 42 may extend from body portion 41 to cover at least part of base 11 and cartridge layer 10a. Sidewall 42 may also extend to cover at least part of cartridge layers 10b and 10c. Furthermore, sidewall 43 may extend to cover at least part of the connecting portion 30a of the electrical connecting member 30 and the base groove 11a where the connecting portion 30a connects with the electrically conductive parts in base 11. As illustrated in FIG. 3, height H1 may be greater than height H2, but this is only an example, and in exemplary embodiments height H1 may be less than H2, or the heights H1 and H2 may be substantially the same.

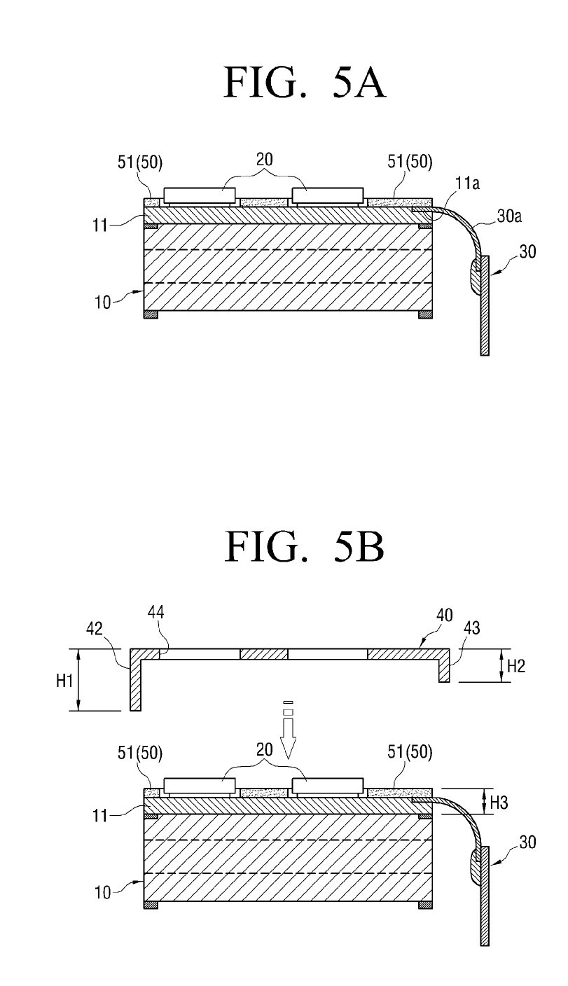

With reference to FIG. 4, when the flat plate cover 40 is disposed on the base 11 of the ink cartridge 10, the surfaces of the plurality of print head chips 20 and the surface of the body portion 41 of the flat plate cover 40 may be positioned at the substantially same level relative to the base 11. In other words, the flat plate cover 40 may be disposed so that a first distance D1 from the surface of the base 11 of the ink cartridge 10 to the surface of the print head chip 20 is substantially the same as a second distance D2 from the surface of the base 11 to the surface of the body portion 41 of the flat plate cover 40. The second distance D2 may include a third distance D3 from the surface of the base 11 to the surface of the adhesive member 50, and fourth distance D4 from the surface of the adhesive member 50 to a surface of the glad plate cover 40. It is also possible that the distance D1 may be less than the distance D2, so that the surface of the print head chip 20 does not protrude above the surface of the flat plate cover 40. A connector 20a may connect the print head chip 20 to 11. Connector 20a may include at least one ink passage (not shown) to permit ink to flow to the print head chip 20.

If the flat plate cover 40 is disposed on the base 11 of the ink cartridge 10 as described above, when a wiper of a maintenance unit 150, as illustrated in FIG. 7, wipes the surfaces of the plurality of print head chips 20, the wiper or the print head chips 20 may be prevented from being damaged. That is, if the plurality of print head chips 20 projects from the surface of the base 11, when the wiper wipes the surfaces of the plurality of print head chips 20, the wiper may impact against corners of the print head chips 20 so that the print head chips 20 and/or the wiper may be damaged. However, the flat plate cover 40 may also be disposed on the ink cartridge 10 so that the surface of the print head chips 20 are higher than the surface of the flat plate cover 40, provided that the difference in heights between the flat plate cover 40 and the surface of the print head chips 20 is sufficiently small that the wiper and/or the print head chips 20 are not damaged when the wiper wipes the surfaces of the print head chips 20. The wiper may include various kinds of wiping apparatuses, such as a wiping blade and a wiping roller, used to wipe the surface of the print head chip 20 of the inkjet image forming apparatus.

Furthermore, when the flat plate cover 40 is disposed on the base 11 of the ink cartridge 10, the surfaces of the plurality of print head chips 20 and the surface of the flat plate cover 40 can form substantially one plane so that a capping operation with respect to the plurality of print head chips 20 may be performed efficiently.

The flat plate cover 40 may be relatively thin so it should also have a certain stiffness. The thickness of the flat plate cover 40 can depend on the height or distance D1 which the print head chips 20 protrude from the base 11 of the ink cartridge 10. In exemplary embodiments, the flat plate cover 40 may have a thickness of approximately 0.1 mm to approximately 1 mm. Also, the flat plate cover 40 may have good heat transmission properties to easily radiate heat generated from the print head chips 20 during a printing operation. Therefore, the flat plate cover 40 may be formed of either a metal material or a ceramic material to have good stiffness and heat transmission properties. The metal material may include stainless steel, copper, aluminum, and an alloy which may include at least one of stainless steel, copper, and aluminum, etc. Also, the ceramic material may include alumina (aluminum oxide), zirconia (zirconium dioxide), and a compound which can include at least one of alumina and zirconia, etc.

An adhesive member 50 may be disposed between the base 11 of the ink cartridge 10 and the flat plate cover 40 so that the flat plate cover 40 is fixed to the base 11 of the ink cartridge 10. Various adhesive materials that can bond the flat plate cover 40 and the base 11 of the ink cartridge 10 and have good heat transmission property, that is, good heat conductivity, may be used as the adhesive member 50. The adhesive member 50 may be, for example, formed as a liquid adhesive, such as a glue or an epoxy, or as a solid adhesive, such as a double-coated tape. That is, a heat conductive liquid adhesive or a heat conductive solid adhesive can be used as the adhesive member 50. When the flat plate cover 40 and the base 11 of the ink cartridge 10 are bonded together by the adhesive member 50, there is no air layer between the flat plate cover 40 and the base 11 of the ink cartridge 10 so that the heat transmission property thereof is enhanced.

In order for the ink cartridge 10, which has the flat plate cover 40 bonded to the base 11 thereof by the adhesive member 50, to efficiently radiate the heat generated from the print head chips 20 during a printing operation, the adhesive member 50 may have large heat conductivity. If the adhesive member 50 has large heat conductivity, the large heat radiation may permit the adhesive member 50 to be formed to have larger thickness. For example, to permit the adhesive member 50 to be 50 μm or more, an adhesive member 50 may be used having a heat conductivity of approximate 0.3 W/mK or more.

Furthermore, the adhesive member 50 may function as a sealing member to prevent ink from penetrating between the flat plate cover 40 and the base 11 during a printing operation. Therefore, the adhesive member 50 should be resistant to the ink used to print. To this end, the adhesive member 50 may include epoxy resin or denatured epoxy resin of 1 wt % (weight %) or more. Here, the denatured epoxy resin may include all kind of epoxy resins that are made of the general epoxy resin and various ingredients added thereto in order to give the general epoxy resin a special property, such as resistance to the printing ink.

The thickness of the adhesive member 50 may be determined so that when the flat plate cover 40 is disposed on the base 11 of the ink cartridge 10, the surface of the body portion 41 of the flat plate cover 40 is positioned at the substantially same level with the surfaces of the plurality of print head chips 20. In exemplary embodiments, the thickness of the adhesive member 50 is determined according to the thickness of the flat plate cover 40 and the projecting height of the print head chips 20. Also, the minimum thickness of the adhesive member 50 may be affected by the flatness of the base 11 of the ink cartridge 10. For example, the base 11 can be machined to have the flatness of approximately 50 μm using present machining techniques. Therefore, in order for the flat plate cover 40 to be evenly bonded to the base 11 of the ink cartridge 10 having the flatness of 50 μm, the adhesive member 50 may have a thickness of 50 μm or more. A much larger thickness of the adhesive member 50 is unfavorable for the heat transmission so that the adhesive member 50 may have the thickness of approximately 300 μm or less. In exemplary embodiments, an adhesive member 50 having a heat conductivity of approximately 0.3 W/mK to approximately 20 W/mK, even if the adhesive member 50 has the thickness of approximately 50 μm to approximately 300 μm, can permit the ink cartridge 10 to perform a high speed printing operation.

Table 1 below illustrates the number of printing media that the inkjet print head 1 according to an exemplary embodiment of the present general inventive concept can print at a high speed, for example, at a printing frequency of 16 KHz, as the heat conductivity and the thickness of the adhesive member 50 are changed.

TABLE 1

| | | Heat | | | | | | | |
|---|---|---|---|---|---|---|---|---|---|
| | | conductivity | | | | | | | |
| | Flat | of adhesive | | | | | | | |
| | plate | member | Thickness of adhesive member(μm) | | | | | | |
| Base | cover | (W/mK) | 20 | 40 | 60 | 100 | 150 | 200 | 300 |
| Ceramic | Stain- | 0.2 | 4 | 4 | 1 | 0 | 0 | 0 | 0 |
| | less | 0.3 | 7 | 7 | 6 | 5 | 5 | 3 | 1 |
| | steel | 1.0 | 8 | 8 | 8 | 6 | 5 | 5 | 3 |
| | | 2.3 | 10 | 10 | 9 | 7 | 7 | 6 | 5 |

As illustrated in Table 1, where the heat conductivity of the adhesive member 50 is 0.2 W/mK, if the thickness of the adhesive member 50 is 60 μm, the inkjet print head 1 can print one page at high speed, and if the thickness thereof is 100 μm or more, the high speed printing operation is impossible.

However, where the adhesive member 50 has a heat conductivity of 0.3 W/mK to 20 W/mK, even if the thickness of the adhesive member 50 is approximately 50 μm to approximately 300 μm, the high speed printing operation is possible. Also, as the heat conductivity of the adhesive member 50 becomes larger, the inkjet print head 1 can print at a higher speed. For example, the ink cartridge 10 using the adhesive member 50 having a heat conductivity is 1.0 W/mK can print at a higher speed than the ink cartridge 10 using an adhesive member 50 having a heat conductivity is 0.3 W/m K. Therefore, in general, the larger the heat conductivity of the adhesive member 50, the thicker the adhesive member 50 may be, and the faster the inkjet print head 1 can perform a high speed printing operation. However, if the heat conductivity of adhesive member 50 is too large, other properties of the adhesive member 50 may deteriorate and the price of the adhesive member 50 may increase, so it is desirable that the adhesive member 50 have a heat conductivity of approximately 0.3 W/mK to approximately 20 W/mK.

The adhesive member 50 may include Eccobond TE3527, XTE80264, E3503-1, CE 3103 WLV, 56 C, 57 C, 50298, C 805-1, C 990, CT 4042-30, CE 3511 P, CE 3514-1, CE 8500, 84-1 LMI, 8175 A, CE 3502, CE 3516, and CE 3104 WXL of Emerson & Cuming Co. of U.S.A., and UT series adhesive tape of Sony chemical Co. of Japan. However, the adhesive members 50 as described above are only examples; therefore, various adhesive members can be used as long as they satisfy the above-described conditions.

The inkjet print head 1 according to exemplary embodiments of the present general inventive concept uses the flat plate cover 40 formed of a metal material so that even if the flat plate cover 40 is formed to have the thickness of 1 mm or less, the flat plate cover 40 has good stiffness and flatness. Therefore, when the wiper of the maintenance unit 150 (see FIG. 7) wipes the plurality of print head chips 20, the wiper and/or the plurality of print head chips 20 are not damaged and the wiper can efficiently clean out the plurality of print head chips 20.

Also, because the flat plate cover 40 is formed of a metal material and is bonded to the base 11 of the ink cartridge 10 by the adhesive member 50 having good heat conductivity, the flat plate cover 40 itself can function as a heat radiating plate. Therefore, during a printing operation the heat generated from the plurality of print head chips 20 can be efficiently radiated to the outside through the flat plate cover 40. If the flat plate cover 40 is formed of a material having poor heat radiation properties such as a plastic, and is disposed on the base 11 of the ink cartridge 10 by the adhesive member 50 having a heat conductivity of less than 0.3 W/mK, the heat generated from the plurality of print head chips 20 is not well radiated to the outside.

If heat is efficiently radiated such as in the inkjet print head 1 according to the present general inventive concept, it takes a long time for the plurality of print head chips 20 to reach a temperature at which the plurality of print head chips 20 cannot eject ink so that the number of printing media which the inkjet print head 1 can print at a high printing frequency is increased. In other words, even if the print head chips 20 eject ink at very short intervals, the number of printing media which the inkjet print head 1 according to the present general inventive concept can print is increased.

Also, in the inkjet print head 1 according to the present general inventive concept, the flat plate cover 40 can function as a heat radiating plate so that the inkjet print head 1 is not required to have a separate heat sink disposed thereon.

In addition, because the heat generated from the plurality of print head chips 20 is efficiently discharged, a pause time to lower the temperature of the inkjet print head 1 may be decreased. Therefore, the inkjet print head 1 can perform a high speed printing operation.

Furthermore, when each of the plurality of print head chips 20 has a different frequency of use, there may be image intensity variation among the plurality of print head chips 20. Because the heat generated from the plurality of print head chips 20 is spread out all over the flat plate cover 40, the temperature around the plurality of print head chips 20 may be averaged. Therefore, image intensity variation among the plurality of print head chips 20 can be reduced.

Hereinafter, a method of manufacturing the inkjet print head 1 according to exemplary embodiments of the present general inventive concept will be explained.

First, the ink cartridge 10 having a plurality of print head chips 20 is prepared. At this time, the plurality of print head chips 20 is formed to protrude a predetermined height from the base 11 of the ink cartridge 10. The ink cartridge 10 having a plurality of print head chips 20 can be made using conventional techniques; therefore, a description thereof is omitted.

Subsequently, the flat plate cover 40 is prepared. The flat plate cover 40 is provided with a plurality of openings 44 through which the plurality of print head chips 20 of the ink cartridge 10 can pass. The flat plate cover 40 may be formed of either a metal material or a ceramic material to have good stiffness and heat conductivity.

Next, the flat plate cover 40 is bonded to the base 11 of the ink cartridge 10 using the adhesive member 50. The adhesive member 50 may have a heat conductivity of 0.3 W/mK or more. Also, a liquid adhesive or a solid adhesive may be used as the adhesive member 50.

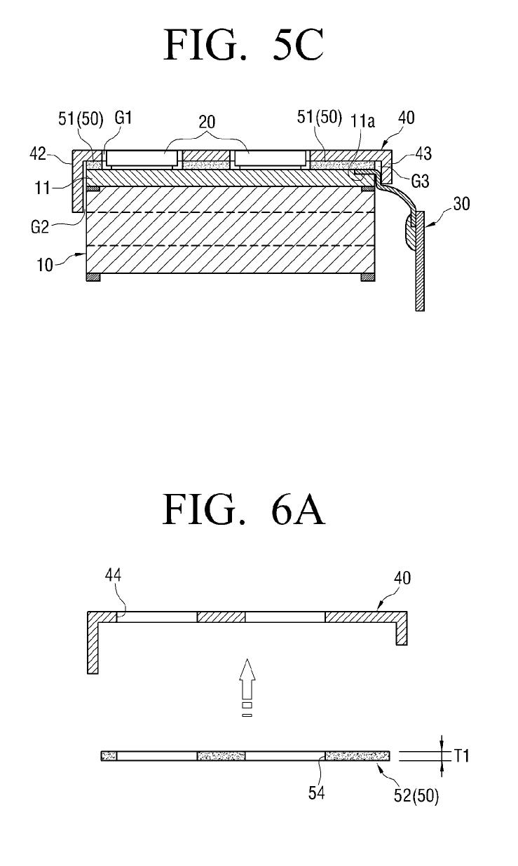

FIGS. 5A to 5C are process views illustrating a method of manufacturing the inkjet print head 1 using the liquid adhesive 51 as the adhesive member 50.

First, as illustrated in FIG. 5A, the adhesive 51 is applied onto the surface of the base 11 of the ink cartridge 10 among the plurality of print head chips 20. The adhesive 51 is also applied to an upper surface of connecting portion 30a of the electrical connecting member 30, which has been formed in base groove 11a in contact with the electrically conductive parts in base 11. At this time, the applied amount of the adhesive 51 may be controlled so that when the flat plate cover 40 is attached to the base 11 of the ink cartridge 10, the surface of the flat plate cover 40 is positioned substantially at the same level as the surfaces of the plurality of print head chips 20.

Next, as illustrated in FIG. 5B, the flat plate cover 40 is attached to the base 11 of the ink cartridge 10. At this time, each of the plurality of print head chips 20 of the ink cartridge 10 is inserted into each of the plurality of openings 44 formed at the flat plate cover 40. Height H3 represents a height from a surface of the base 11 to a surface of the adhesive 51. In exemplary embodiments, the height H2 of sidewall 43 may be less than height H3. However, height H2 may also be greater than height H3, or the heights H2 and H3 may be substantially the same. Accordingly, sidewall 43 may extend from body portion 41 to cover adhesive 51 and at least part of connecting portion 30a. Similarly, sidewall 42 may extend from body portion 41 to cover at least part of base 11 and cartridge layer 10a. Sidewall 42 may also extend to cover at least part of cartridge layers 10b and 10c. Sidewall 42 may be in contact with adhesive 51, base 11, and cartridge layer 10a (and 10b and 10c, if sidewall 42 so extends), or a small gap G2 may be formed between sidewall 42 and the adhesive 51, base 11 and the cartridge layers. Sidewall 43 may be in contact with adhesive 51 and connecting portion 30a, or a small gap G3 may be formed between sidewall 43 and the adhesive 51 and connecting portion 30a.

Then, the height of the flat plate cover 40 is adjusted so that the surface of the flat plate cover 40 is positioned substantially at the same level as the surfaces of the plurality of print head chips 20 as illustrated in FIG. 5C. A gap G1 may be formed between the flat cover plate 40 and the inkjet print heads 20. The gap G1 may be filled with an appropriate material, for example, a sealant or an adhesive, which may include adhesive 51. As time passes, the adhesive 51 hardens so the assembly of the inkjet print head 1 is complete.

FIGS. 5A to 5C illustrate a manufacturing method where the adhesive 51 is first applied onto the base 11 of the ink cartridge 10. Alternatively, the adhesive 51 can be first applied onto an inner surface of the flat plate cover 40, and then the flat plate cover 40 can be attached to the base 11 of the ink cartridge 10.

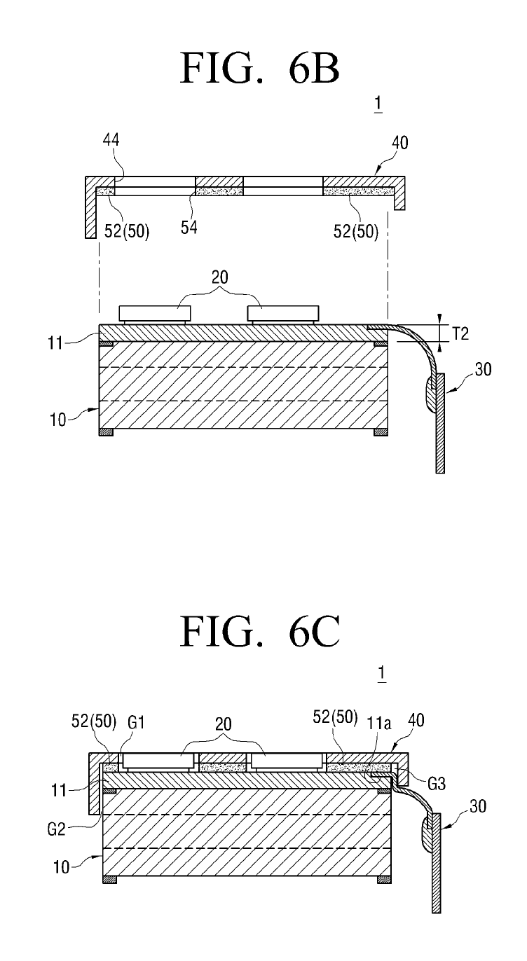

FIGS. 6A to 6C are process views illustrating a method of manufacturing the inkjet print head 1 using the solid adhesive 52 as the adhesive member 50.

First, as illustrated in FIG. 6A, the solid adhesive 52 is attached onto the inner surface of the flat plate cover 40. At this time, each of the plurality of holes 54 formed at the solid adhesive 52 is aligned to each of the plurality of openings 44 of the flat plate cover 40.

Next, as illustrated in FIG. 6B, the flat plate cover 40 onto which the solid adhesive 52 is attached is attached to the base 11 of the ink cartridge 10. At this time, each of the plurality of print head chips 20 of the ink cartridge 10 is inserted into each of the plurality of openings 44 formed at the flat plate cover 40. The solid adhesive 52 is also applied to an upper surface of connecting portion 30a of the electrical connecting member 30, which has been formed in base groove 11a in contact with the electrically conductive parts in base 11. Solid adhesive 52 may have a thickness T1. Base 11 may have a thickness T2. In exemplary embodiments the thickness T1 of the solid adhesive 52 may be smaller than the thickness T2 of the base 11. Thickness T1 may be, for example, approximately 50 μm to approximately 300 μm. Thickness T1 may also be greater than or equal to thickness T2. Also, in exemplary embodiments, the height H2 of sidewall 43 may be less than height H3. However, height H2 may also be greater than height H3, or the heights H2 and H3 may be substantially the same. Accordingly, sidewall 43 may extend from body portion 41 to cover solid adhesive 52 and at least part of connecting portion 30a. Similarly, sidewall 42 may extend from body portion 41 to cover at least part of base 11 and cartridge layer 10a. Sidewall 42 may also extend to cover at least part of cartridge layers 10b and 10c. Sidewall 42 may be in contact with solid adhesive 52, base 11, and cartridge layer 10a (and 10b and 10c, if sidewall 42 so extends), or a small gap G2 may be formed between sidewall 42 and the solid adhesive 52, base 11 and the cartridge layers. Sidewall 43 may be in contact with solid adhesive 52 and connecting portion 30a, or a small gap G3 may be formed between sidewall 43 and the solid adhesive 52 and connecting portion 30a.

After the solid adhesive 52 attached on the inner surface of the flat plate cover 40, as illustrated in FIG. 6C, is attached on the base 11 of the ink cartridge 10, the assembly of the flat plate cover 40 is complete. A gap G1 may be formed between the flat cover plate 40 and the inkjet print heads 20. The gap G1 may be filled with an appropriate material, for example, a sealant or an adhesive, which may include adhesive 51.

FIGS. 6A to 6C illustrate a manufacturing method in where the solid adhesive 52 is first attached onto the flat plate cover 40. Alternatively, the solid adhesive 52 may be first attached onto the base 11 of the ink cartridge 10, and then the flat plate cover 40 may be attached on the solid adhesive 52.

FIG. 7 is a sectional view schematically illustrating an image forming apparatus 100 using the inkjet print head 1 according to exemplary embodiments of the present general inventive concept.

The image forming apparatus 100 according to exemplary embodiments of the present general inventive concept may include a printing media storing unit 110, a feeding unit 120, the inkjet print head 1, a discharging unit 130, and the maintenance unit 150.

The printing media storing unit 110 stores a predetermined number of printing media P, and has a pickup roller 151 that picks up printing media P one by one and is disposed at a leading end thereof.

The feeding unit 120 conveys the printing medium P picked up from the printing media storing unit 110 below the array type inkjet print head 1 and includes a pair of feeding rollers. A transferring passage 121 and a pair of conveying rollers 123 are disposed between the feeding unit 120 and the printing media storing unit 110 to convey the printing medium P to the feeding unit 120.

The inkjet print head 1 receives a printing command and printing data from a control portion (not illustrated) and ejects ink corresponding to the printing data so as to form predetermined images on the printing medium P. The inkjet print head 1 is described above; therefore, a detailed description thereof will not be repeated.

A printing medium supporting plate 140 is disposed below the inkjet print head 1. Therefore, the printing medium P conveyed by the feeding unit 120 is positioned between the printing medium supporting plate 140 and the plurality of print head chips 20 of the inkjet print head 1.

The discharging unit 130 discharges the printing medium P printed by the inkjet print head 1, and includes a pair of discharging rollers.

The maintenance unit 150 is disposed below the inkjet print head 1 and is formed to perform wiping and capping operations with respect to the plurality of print head chips 20 of the inkjet print head 1. The maintenance unit 150 may include a wiper to wipe the plurality of print head chips 20. The wiper may be formed of an elastic member such as a rubber, and is formed to move while contacting the surface of the flat plate cover 40 of the inkjet print head 1. When the maintenance unit 150 operates to perform maintenance on the inkjet print head 1, the printing medium supporting plate 140 moves out of a space below the inkjet print head 1.

When the control portion (not illustrated) of the image forming apparatus 100 receives a printing order, the control portion operates the pickup roller 151 of the printing media storing unit 110 to pick up a printing medium P. The picked up printing medium P is moved to the feeding unit 120 through the transferring passage 121 via the conveying rollers 123. After the feeding unit 120 positions the printing medium P on the printing medium supporting plate 140 below the inkjet print head 1, the inkjet print head 1 ejects ink to form a predetermined image on the printing medium P.

The discharging unit 130 then discharges the printing medium P on which the image is formed outside of the image forming apparatus 100.

Thus, in the inkjet print head 1 according to exemplary embodiments of the present general inventive concept, the flat plate cover 40 having good heat conductivity is attached using the adhesive member 50 having good heat conductivity so that heat generated from the plurality of print head chips 20 during a printing operation is efficiently radiated through the flat plate cover 40. Therefore, the temperature of the inkjet print head 1 does not increase rapidly. Accordingly, the inkjet print head 1 according to exemplary embodiments of the present general inventive concept can be used in image forming apparatuses capable of performing a high speed printing operation.

Also, in the inkjet print head 1 according to exemplary embodiments of the present general inventive concept, the base 11 of the ink cartridge 10 is covered by the flat plate cover 40 to form one plane so that the maintenance unit 150 can efficiently clean up the plurality of print head chips 20.

Although several exemplary embodiments of the present general inventive concept have been shown and described, it will be appreciated by those skilled in the art that changes may be made in these exemplary embodiments without departing from the principles and spirit of the general inventive concept, the scope of which is defined in the appended claims and their equivalents.

What is claimed is:

1. An array type inkjet print head, comprising:
an ink cartridge to store ink;
at least one print head chip disposed on a base of the ink cartridge to eject the ink;
a flat plate cover disposed on the base of the ink cartridge and having at least one opening corresponding to the at least one print head chip; and
an adhesive member disposed between the base of the ink cartridge and the flat plate cover to fix the flat plate cover to the base of the ink cartridge,
wherein the flat plate cover is formed of either a metal material or a ceramic material.

2. The array type inkjet print head of claim 1, wherein the adhesive member is formed of a heat conductive material.

3. The array type inkjet print head of claim 2, wherein the adhesive member is formed to have a thickness of approximately 50 μm to approximately 300 μm.

4. The array type inkjet print head of claim 3, wherein the adhesive member has heat conductivity of 0.3 W/mK or more.

5. The array type inkjet print head of claim 2, wherein the adhesive member comprises at least one of a liquid adhesive and a solid adhesive having at least one hole corresponding to the at least one print head chip.

6. The array type inkjet print head of claim 2, wherein the adhesive member includes an epoxy resin or a denatured epoxy resin of at least 1 weight percent.

7. The array type inkjet print head of claim 1, wherein the metal material includes stainless steel, copper, aluminum, and an alloy including at least one of stainless steel, copper, and aluminum.

8. The array type inkjet print head of claim 1, wherein the ceramic material includes at least one of alumina, zirconia, and a compound including at least one of alumina and zirconia.

9. The array type inkjet print head of claim 1, wherein the flat plate cover has a thickness of approximately 0.1 mm to approximately 1.0 mm.

10. An image forming apparatus, comprising:
a feeding unit to feed a printing medium;
an array type inkjet print head to form images on the printing medium fed by the feeding unit, the array type inkjet print head including:
an ink cartridge to store ink;
at least one print head chip disposed on a base of the ink cartridge to eject the ink;
a flat plate cover disposed on the base of the ink cartridge and having at least one opening corresponding to the at least one print head chip, the flat plate cover formed of either a metal material or a ceramic material; and
an adhesive member disposed between the base of the ink cartridge and the flat plate cover to fix the flat plate cover to the base of the ink cartridge; and
a discharging unit to discharge the printing medium printed by the array type inkjet print head.

11. The array type inkjet print head of claim 1, further comprising:
an electrical connecting member disposed between the flat plate cover and the ink cartridge to provide electrical signals to the at least one print head chip.

12. The inkjet print head of claim 11, wherein a sidewall of the flat plate cover covers at least a portion of the electrical connecting member.
